(19) United States
(12) Patent Application Publication
(10) Pub. No.: US 2023/0182366 A1
(43) Pub. Date: Jun. 15, 2023

(54) Extrusion Blow Molded Containers And Processes For Making Same

(71) Applicant: ExxonMobil Chemical Patents Inc., Baytown, TX (US)

(72) Inventors: Allen T. MIKA, Huffman, TX (US); Jeffery C. FITCH, Spring, TX (US)

(21) Appl. No.: 17/998,122

(22) PCT Filed: May 4, 2021
(86) PCT No.: PCT/US2021/030646

§ 371 Date: Nov. 7, 2022

Related U.S. Application Data
(60) Provisional application No. 63/026,902, filed on May 19, 2020.

(51) Int. Cl. B29C 49/04; C08L 23/08; C08L 23/12; B65D 1/02; B65D 25/56

(52) U.S. Cl. CPC B29C 49/04; C08L 23/0815; C08L 23/12; B65D 1/0223; B65D 25/56; C08L 2205/025

(57) ABSTRACT

Extrusion blow molded containers and processes for making same. In some embodiments, the container can include a body that can have a top, a bottom, and a sidewall connected to the top and bottom. The body can define a volume. A first section of the sidewall can include an opaque polymer composition and a second section of the sidewall can include a translucent polymer composition that provides a viewing window into the volume. The translucent polymer composition can include a first polyethylene copolymer derived from ethylene and at least one C₃ to C₂₀ α-olefin. The first polyethylene copolymer can have an I_{2.16} (190° C./2.16 kg) of about 0.2 g/10 min to about 1 g/10 min, a melt index ratio of about 30 g/10 min to about 80 g/10 min, and a density of about 0.910 g/cm³ to about 0.940 g/cm³.

### CROSS-REFERENCE APPLICATION

This application claims the benefit of U.S. Provisional Application 63/026,902 filed May 19, 2020 entitled “Extrusion Blow Molded Containers And Processes For Making Same”, the entirety of which is incorporated by reference herein.

### FIELD

Embodiments disclosed herein generally relate to extrusion blow molded containers and processes for making same. More particularly, such embodiments relate to extrusion blow molded containers that include a viewing window and processes for making same.

### BACKGROUND

Extrusion blow molded containers made of thermoplastic materials, e.g., bottles and other containers, have been used to package a wide variety of products such as those in the food, cosmetic, shampoo, laundry, and automotive categories. Typically, such containers are made from an opaque thermoplastic material to allow for advertising, product information, etc. to be printed or otherwise placed onto the container. A disadvantage of such opaque containers, however, is that the opaque walls prevent one from being able to see the level of contents in the container.

A viewing window has been incorporated into generally opaque containers so that the level of the contents therein can be viewed. One problem with the current viewing window is, while somewhat transparent, the level of transmittance is rather low, which makes determination of the level of the contents within the container difficult.

There is a need, therefore, for extrusion blow molded containers having a viewing window that has an increased transmittance and processes for making same.

### SUMMARY

Extrusion blow molded containers and processes for making same are provide. In some embodiments, the container can include a body. The body can include a top, a bottom, and a sidewall connected to the top and bottom. The body can define a volume. A first section of the sidewall can include an opaque polymer composition and a second section of the sidewall can include a translucent polymer composition that provides a viewing window into the volume. The translucent polymer composition can include a first polyethylene copolymer derived from ethylene and at least one C₃ to C₂₀ α-olefin. The first polyethylene copolymer can have an I_{2.16} (190° C./2.16 kg) of about 0.2 g/10 min to about 1 g/10 min, a melt index ratio of about 30 g/10 min to about 80 g/10 min, and a density of about 0.910 g/cm³ to about 0.940 g/cm³.

In some embodiments, the process for making the container can include coextruding a first polymer composition and a second polymer composition to produce a parison having a first section comprising the first polymer composition and a second section comprising the second polymer composition. A mold can be closed around the parison. A fluid can be injected into the mold to inflate the parison against an inner surface of the mold to form the container. The container can be removed from the mold. The container can include a body. The body can include a top, a bottom, and a sidewall connected to the top and bottom. The body can define a volume. The first polymer composition can form the first section and can be opaque. The second polymer composition can form the second section and can be translucent to provide a viewing window into the volume. The second polymer composition can include a first polyethylene copolymer derived from ethylene and at least one C₃ to C₂₀ α-olefin. The first polyethylene copolymer can have an I_{2.16} (190° C./2.16 kg) of about 0.2 g/10 min to about 1 g/10 min, a melt index ratio of about 30 g/10 min to about 80 g/10 min, and a density of about 0.910 g/cm³ to about 0.940 g/cm³.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic of an illustrative container, according to one or more embodiments described.

### DETAILED DESCRIPTION

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

As used herein, the indefinite article “a” or “an” shall mean “at least one” unless specified to the contrary or the context clearly indicates otherwise. Thus, embodiments using “an alpha-olefin” include embodiments where one, two or more alpha-olefins are used, unless specified to the contrary or the context clearly indicates that only one alpha-olefin is used.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for acquiring the measurement.

As used herein, “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

An “olefin” is a linear, branched, or cyclic compound of carbon and hydrogen having at least one double bond. For purposes of this specification and the claims appended thereto, when a polymer or copolymer is referred to as including an olefin, e.g., ethylene and at least one C₃ to C₂₀ α-olefin, the olefin present in such polymer or copolymer is the polymerized form of the olefin. For example, when a copolymer is said to have an “ethylene” content of about 35 wt % to about 55 wt %, it is understood that the repeating unit/mer unit or simply unit in the copolymer is derived from ethylene in the polymerization reaction and the derived units are present at about 35 wt % to about 55 wt %, based on a weight of the copolymer.

A “polymer” has two or more of the same or different repeating units/mer units or simply units. A “homopolymer” is a polymer having units that are the same. A “copolymer” is a polymer having two or more units that are different from each other. A “terpolymer” is a polymer having three units that are different from each other. The term “different” as used to refer to units indicates that the units differ from each other by at least one atom or are different isomerically. The definition of copolymer, as used herein, includes terpolymers and the like. Likewise, the definition of polymer, as used herein, includes homopolymers, copolymers, and the like. Furthermore, the terms “polyethylene copolymer”, “polyethylene”, “ethylene polymer”, “ethylene copolymer”, and “ethylene-based polymer” are used interchangeably to refer to a copolymer that includes at least 50 mol % of units derived from ethylene.

Nomenclature of elements and groups thereof used herein are pursuant to the Periodic Table used by the International Union of Pure and Applied Chemistry after 1988. An example of the Periodic Table is shown in the inner page of the front cover of Advanced Inorganic Chemistry, 6^{th} Edition, by F. Albert Cotton et al. (John Wiley & Sons, Inc., 1999).

The terms “melt index” and “MI” are used interchangeably and refer to the number of grams extruded in 10 minutes under the action of a standard load (2.16 kg) and is an inverse measure of viscosity. A high MI implies low viscosity and a low MI implies high viscosity. In addition, polymers can have shear thinning behavior, which means that their resistance to flow decreases as the shear rate increases. This is due to molecular alignments in the direction of flow and disentanglements. As provided herein, the melt index is determined according to ASTM D-1238-E (190° C./2.16 kg), also sometimes referred to as I₂ or I_{2.16}.

The terms “high load melt index” and “HLMI” are used interchangeably and refer to the number of grams extruded in 10 minutes under the action of a standard load (21.6 kg) and is an inverse measure of viscosity. As provided herein, high load melt index is determined according to ASTM D-1238-F (190° C./21.6 kg), also sometimes referred to as I₂₁ or I_{21.6}.

The terms “melt index ratio” and “MIR” are used interchangeably and provide an indication of the amount of shear thinning behavior of the polymer and is a parameter that can be correlated to the overall polymer mixture molecular weight distribution data obtained separately by using Gel Permeation Chromatography (“GPC”) and possibly in combination with another polymer analysis including TREF. The melt index ratio is the ratio of I₂₁/I₂.

The transmittance of the viewing window is determined according to ASTM D1746-15, with conditioning for 40 hours at a temperature of 23+/−2° C. and 50+/−10% relative humidity. The “average transmittance” is the sum of the transmittance values in the machine direction and the transverse direction measured for a given sample, where the transmittance is measured three times in the machine direction and three times in the transverse direction such that the average transmittance is equal to the sum of the six transmittance values divided by six.

Containers with a Viewing Window

In some embodiments, the container can include a body that can have a top, a bottom, and a sidewall connected to the top and bottom, with the body defining a volume. A first section of the sidewall can be composed of a colored or opaque polymer composition and a second section of the sidewall can be composed of a translucent polymer composition that can provide a viewing window into the volume. The colored or opaque polymer composition can also be referred to as a “first” polymer composition and the translucent polymer composition can also be referred to as a “second” polymer composition. The translucent polymer composition or the second polymer composition can be or can include a first polyethylene copolymer derived from ethylene and at least one C₃ to C₂₀ α-olefin and having an I_{2.16} (190° C./2.16 kg) of about 0.2 g/10 min to about 1 g/10 min, a melt index ratio of about 30 g/10 min to about 80 g/10 min, and a density of about 0.910 g/cm³ to about 0.940 g/cm³.

It has been surprisingly and unexpectedly discovered that, when the second section of the sidewall includes the first polyethylene copolymer and has an average thickness of about 0.3 mm to 3 mm, e.g., 1.9 mm to 2.1 mm, the second section of the sidewall, i.e., the viewing window, can have an average transmittance of at least 1%, at least 1.5%, at least 1.8%, at least 2%, at least 2.5%, at least 3%, at least 3.5%, at least 4%, at least 4.5%, at least 5%, at least 5.5%, at least 6%, at least 6.5%, at least 7%, at least 7.5%, at least 8%, at least 8.5%, or at least 9%. Prior to making the container having a viewing window composed of the translucent polymer composition that includes the first polyethylene copolymer, it was believed that it would not be possible to make a satisfactory container with the translucent polymer composition that includes the first polyethylene. Historically the first polyethylene copolymer has not processed well with other extrusion blow molding resins because of unacceptable melt fracture, poor gage control, and poor wall integrity. Surprisingly and unexpectedly a viable viewing window that both processes well and shows significantly greater average transmittance than the standard high density polyethylene resin was produced with the translucent polymer composition that included the first polyethylene copolymer described herein.

In some embodiments, the second section of the sidewall made or otherwise formed from the translucent polymer composition or the second polymer composition can have an average thickness of about 0.3 mm, about 0.5 mm, or about 0.7 mm to about 0.9 mm, about 1 mm, about 1.5 mm, or about 2 mm, about 2.5 mm, or about 3 mm and can have an average transmittance of at least 1%, at least 1.5%, at least 2%, at least 3%, at least 4%, at least 5%, at least 6%, at least 7%, at least 8%, at least 9%, or at least 10%, as measured according to ASTM D1746-15. As noted above, the average transmittance is the sum of the transmittance values in the machine direction and the transverse direction measured for a given sample, where the transmittance is measured three times in the machine direction and three times in the transverse direction such that the average transmittance is equal to the sum of the six transmittance values divided by six. In other embodiments, the second section of the sidewall made or otherwise formed from the translucent polymer composition or the second polymer composition can have an average thickness of about 1.5 mm to about 3 mm and can have an average transmittance of about 1%, about 1.3%, about 1.5%, about 1.7%, or about 2% to about 7%, about 8%, about 9%, about 10%, about 11%, or about 12%. In other embodiments, the second section of the sidewall made or otherwise formed from the translucent polymer composition or the second polymer composition can have an average thickness of about 1.8 mm to about 2.2 mm and an average transmittance of about 1%, about 1.3%, about 1.5%, about 1.7%, or about 2% to about 7%, about 8%, about 9%, about 10%, about 11%, or about 12%.

### The Translucent/Second Polymer Composition

The translucent polymer composition or the second polymer composition can be or can include, but is not limited to, the first polyethylene copolymer. In some embodiments, the translucent or second polymer composition can be or can include, but is not limited to, a blended polymer composition that can include the first polyethylene copolymer and one or more additional polyethylene copolymers. The additional polyethylene copolymers can include, but are not limited to, bimodal, unimodal, homopolymers, and mixed density Post Consumer PE Recycle (PCR), or a mixture thereof. In this embodiment, the blended polymer composition can include the first polyethylene copolymer in an amount of at least 50 wt %, at least 60 wt %, at least 70 wt %, at least 80 wt %, or at least 90 wt %. In some embodiments, the translucent or second polymer composition can be or can substantially be composed of the first polyethylene copolymer. For example, the translucent or second polymer composition can be composed of at least 90 wt %, at least 95 wt %, or at least 99 wt % of the first polyethylene copolymer.

### The First Polyethylene Copolymer

The first polyethylene copolymer can include repeating/mer units or units derived from ethylene and units derived from at least one C₃-C₂₀ α-olefin. In some embodiments, the first polyethylene copolymer can include about 70 mol %, about 80 mol %, about 85 mol %, or about 90 mol % to about 95 mol %, about 96 mol %, about 97 mol %, about 98 mol %, or about 99 mol % of units derived from ethylene, based on a combined weight of the units derived from ethylene and the units derived from the at least one C₃-C₂₀ α-olefin. In some embodiments, the first polyethylene copolymer can include about 1 mol %, about 1.5 mol %, about 2 mol %, about 2.5 mol %, about 3 mol %, about 3.5 mol %, or about 4 mol % to about 5 mol %, about 7 mol %, about 10 mol %, about 15 mol %, about 20 mol %, or about 30 mol % of units derived from at least one C₃-C₂₀ α-olefin, based on the combined weight of the units derived from ethylene and the units derived from the at least one C₃-C₂₀ α-olefin. In other embodiments, the first polyethylene copolymer can include about 80 wt %, about 83 wt %, about 85 wt %, about 87 wt %, about 90 wt %, about 93 wt %, or about 95 wt % to about 96 wt %, about 97 wt %, about 98 wt %, or about 99 wt % of units derived from ethylene and about 1 wt %, about 2 wt %, about 3 wt %, about 4 wt %, about 5 wt %, or about 7.5 wt % to about 10 wt %, about 13 wt %, about 15 wt %, about 17 wt %, or about 20 wt % units derived from C₃-C₂₀ α-olefins, based on the combined weight of the units derived from ethylene and the units derived from the at least one C₃-C₂₀ α-olefin.

The C₃-C₂₀ α-olefin can have a terminal carbon-to-carbon double bond in the structure thereof ((R¹R²)—C═CH₂, where R¹ and R² can independently be hydrogen or any hydrocarbyl group). In some embodiments, R¹ can be hydrogen and R² can be an alkyl group. The C₃-C₂₀ α-olefin can be linear or branched. In some embodiments, the C₃-C₂₀ α-olefin can be or can include, but is not limited to, propylene, 1-butene, 1-pentene, 1-hexene, 1-heptene, 1-octene, 1-nonene, 1-decene, 1-undecene 1-dodecene, 1-tridecene, 1-tetradecene, 1-pentadecene, 1-hexadecene, 1-heptadecene, 1-octadecene, 1-nonadecene, 1-eicosene, 4-methyl-1-pentene, 3-methyl-1-pentene, 5-methyl-1-nonene, 3,5,5-trimethyl-1-hexene, or any mixture thereof. In other embodiments, the C₃-C₂₀ α-olefin can be or can include 1-pentene, 1-pentene with one or more methyl, ethyl, or propyl substituents, 1-hexene, 1-hexene with one or more methyl, ethyl, or propyl substituents, 1-heptene, 1-heptene with one or more methyl, ethyl, or propyl substituents, 1-octene, 1-octene with one or more methyl, ethyl, or propyl substituents, 1-nonene, 1-nonene with one or more methyl, ethyl, or propyl substituents, 1-decene, 1-decene with one or more methyl, ethyl, or propyl substituents, 1-dodecene, and/or 1-dodecene with one or more methyl, ethyl, or propyl substituents, or any mixture thereof. In some embodiments, the C₃-C₂₀ α-olefin can be or can include, but is not limited to, 1-hexene, 1-octene, or a mixture thereof.

The first polyethylene copolymer can have a melt index (I_{2.16}) of about 0.2 g/10 min, about 0.23 g/10 min, about 0.25 g/10 min, about 0.27 g/10 min, about 0.3 g/10 min, about 0.33 g/10 min, about 0.35 g/10 min, about 0.37 g/10 min, about 0.4 g/10 min, about 0.43 g/10 min, about 0.45 g/10 min, about 0.47 g/10 min, or about 0.5 g/10 min to about 0.53 g/10 min, about 0.55 g/10 min, about 0.57 g/10 min, about 0.6 g/10 min, about 0.65 g/10 min, about 0.7 g/10 min, about 0.75 g/10 min, about 0.8 g/10 min, about 0.85 g/10 min, about 0.9 g/10 min, about 0.95 g/10 min, or about 1 g/10 min. In some embodiments, the first polyethylene copolymer can have a melt index (I_{2.16}) of less than 1 g/10 min, less than 0.95 g/10 min, less than 0.9 g/10 min, less than 0.85 g/10 min, less than 0.8 g/10 min, less than 0.75 g/10 min, less than 0.7 g/10 min, less than 0.65 g/10 min, less than 0.6 g/10 min, less than 0.55 g/10 min, less than 0.5 g/10 min, or less than 0.4 g/10 min, or less than 0.35 g/10 min, or less than 0.3 g/10 min. The melt index (I_{2.16}) of the first polyethylene copolymer and other polymers can be measured according to ASTM D-1238-13, condition E (190° C., 2.16 kg), and also referred to as “I₂ (190° C./2.16 kg)”.

The first polyethylene copolymer can have a melt index (I_{21.6}) of about 10 g/10 min, about 12 g/10 min, about 14 g/10 min, about 16 g/10 min, about 18 g/10 min, about 20 g/10 min, or about 22 g/10 min to about 26 g/10 min, about 28 g/10 min, about 30 g/10 min, about 32 g/10 min, about 34 g/10 min, about 36 g/10 min, about 38 g/10 min, or about 40. The melt index (I_{21.6}) of the first polyethylene copolymer and other polymers can be measured according to ASTM D-1238-13, condition F (190° C., 21.6 kg), and also referred to as “I_{21.6} (190° C./21.6 kg)”.

The first polyethylene copolymer can have a melt index ratio (I_{21.6}/I_{2.16}) of at least 30, at least 31, at least 32, at least 33, at least 34, at least 35, at least 36, at least 37, at least 38, at least 39, at least 40, at least 41, or at least 42 to about 50, about 55, about 60, about 65, about 70, about 75, or about 80. In some embodiments, the melt index ratio (I_{21.6}/I_{2.16}) can be greater than 30, greater than 31, greater than 32, greater than 33, greater than 34, greater than 35, greater than 36, greater than 37, greater than 38, greater than 39, or greater than 40 to about 50, about 55, about 60, about 65, about 70, about 75, or about 80.

The first polyethylene copolymer can have a density of about 0.910 g/cm³, about 0.913 g/cm³, about 0.915 g/cm³, about 0.917 g/cm³, about 0.920 g/cm³, about 0.923 g/cm³, or about 0.925 g/cm³ to about 0.927 g/cm³, about 0.930 g/cm³, about 0.933 g/cm³, about 0.935 g/cm³, about 0.937 g/cm³, about 0.940 g/cm³, about 0.943 g/cm³, or about 0.945 g/cm³. In some embodiments, the first polyethylene copolymer can have a density of less than 0.940 g/cm³, less than 0.935 g/cm³, less than 0.930 g/cm³, or less than 0.925 g/cm³. The density can be measured using chips cut from plaques compression molded in accordance with ASTM D-1928-96 Procedure C, aged in accordance with ASTM D-618-13 Procedure A, and measured as specified by ASTM D-1505-18. In some embodiments, the first polyethylene copolymer can have a melt index (I_{2.16}) of about 0.2 g/10 min to about 1 g/10 min, a melt index ratio (I_{21.6}/I_{2.16}) of at least 30 to about 80, and a density of about 0.910 g/cm³ to about 0.940 g/cm³.

In some embodiments, the first polyethylene copolymer can have a molecular weight distribution (Mw/Mn) of about 2, about 2.5, about 3, or about 3.4 to about 4, about 4.5, about 5, about 5.5, about 6, or about 6.5. The molecular weight (weight-average molecular weight (Mw) and number-average molecular weight (Mn) can be determined using Gel Permeation Chromatography. For the GPC data, the differential refractive index (DRI) method is preferred for Mn, while light scattering (LS) is preferred for Mw and Mz. The GPC can be performed on a Waters 150C GPC instrument with DRI detectors. GPC Columns can be calibrated by running a series of narrow polystyrene standards. Molecular weights of polymers other than polystyrenes are conventionally calculated by using Mark Houwink coefficients for the polymer in question.

The first polyethylene copolymer can have a Composition Distribution Breadth Index (CDBI) of at least 70%, e.g., about 75% or more, about 80% or more, about 82% or more, about 85% or more, about 87% or more, about 90% or more, about 95%, about 98% or more, about 100%. CDBI is defined as the weight percent of the copolymer molecules having a comonomer content within 50% of the median total molar comonomer content, and it is described in U.S. Pat. No. 5,382,630, which is hereby incorporated by reference. The CDBI of a copolymer is readily determined utilizing well known techniques for isolating individual fractions of a sample of the copolymer. One such technique is Temperature Rising Elution Fraction (TREF), as described in Wild, et al., J. Poly. Sci., Poly. Phys. Ed., vol. 20, p. 441 (1982) and U.S. Pat. No. 5,008,204, which are incorporated herein by reference. In some embodiments, the first polyethylene copolymer can have a CDBI of about 70%, about 75%, about 77%, about 80%, or about 82% to about 85%, about 87%, about 90%, about 93%, or about 95%.

The first polyethylene copolymer can have long-chain branches. Long-chain branches represent the branches formed by reincorporation of vinyl-terminated macromers, not the branches formed by incorporation of the comonomers. The number of carbon atoms on the long-chain branches can be from a chain length of at least one carbon more than two carbons less than the total number of carbons in the comonomer to several thousands. For example, a long-chain branch of a polyethylene copolymer that includes units derived from ethylene and hexene can be at least five (5) carbons in length (i.e., 6 carbons less 2 equals 4 carbons plus one equals a minimum branch length of five carbons for long-chain branches). In some embodiments, the first polyethylene copolymer can have about 0.05, or about 0.1, or about 0.2 to about 0.3, about 0.4, about 0.5, or about 1 long-chain branches per 1,000 carbon atoms. Ethylene-based polymers having levels of long-chain branching greater than 1 long-chain branch per 1,000 carbon atoms may have some beneficial properties, e.g., improved processability, shear thinning, and/or delayed melt fracture, and/or improved melt strength.

Various methods are known for determining the presence of long-chain branches. For example, long-chain branching can be determined using ¹³C nuclear magnetic resonance (NMR) spectroscopy. Although conventional ¹³C NMR spectroscopy cannot determine the length of a long-chain branch in excess of about six carbon atoms, there are other known techniques useful for quantifying or determining the presence of long-chain branches in polyethylene copolymers such as a polyethylene copolymer that includes ethylene derived units and 1-octene derived units. For those ethylene-based polymers where the ¹³C resonances of the comonomer overlap completely with the ¹³C resonances of the long-chain branches, either the comonomer or the other monomers (such as ethylene) can be isotopically labeled so that the long-chain branches can be distinguished from the comonomer. For example, a copolymer of ethylene and 1-octene can be prepared using ¹³C-labeled ethylene. In this case, the resonances associated with macromer incorporation will be significantly enhanced in intensity and will show coupling to neighboring ¹³C carbons, whereas the octene resonances will be unenhanced.

The short chain branching (SCB) can be measured by hydrogen nuclear magnetic resonance (HNMR) with data collected at 500 Mhz. The spectra can be referenced by setting the polymer backbone signal to 1.347 ppm. The methyl group content in ethylene 1-olefin copolymers can be calculated from the HNMR spectrum using the following formula: Methyl Groups/1000 Carbons=(I_{CH3}*0.33*1000)/(I_{0.5-2.1 ppm}*0.5), where I_{CH3} is the normalized methyl signal area in the region between 0.88 and 1.05 ppm and I_{0.5-2.1 ppm} is the area between 0.50 and 2.10 ppm. The amount of methyl groups corresponds to the number of short chain branches in the polymer assuming that the short chain branches contain 1 methyl (—CH₃) group and that all methyl groups are a result of short chain branching. The same NMR method can be used to determine vinyl end unsaturation.

In some embodiments, the first polyethylene copolymer can have a melt index (I_{2.16}) of about 0.2 g/10 min to about 1 g/10 min, a melt index ratio (I_{21.6}/I_{2.16}) of at least 30 to about 80, a density of about 0.910 g/cm³ to about 0.940 g/cm³, and an Izod (impact) at 23° C. of about 8 ft-lb/in, about 9 ft-lb/in, about 10 ft-lb/in, or about 11 ft-lb/in to about 12 ft-lb/in, about 13 ft-lb/in, about 14 ft-lb/in, or about 15 ft-lb/in. In some embodiments, the first polyethylene copolymer can have a melt index (I_{2.16}) of about 0.2 g/10 min to about 1 g/10 min, a melt index ratio (I_{21.6}/I_{2.16}) of at least 30 to about 80, a density of about 0.910 g/cm³ to about 0.940 g/cm³, an Izod (impact) at 23° C. of about 8 ft-lb/in, about 9 ft-lb/in, about 10 ft-lb/in, or about 11 ft-lb/in to about 12 ft-lb/in, about 13 ft-lb/in, about 14 ft-lb/in, or about 15 ft-lb/in, and an Izod (impact) at 0° C. of about 4 ft-lb/in, about 5 ft-lb/in, about 6 ft-lb/in, about 7 ft-lb/in, or about 8 ft-lb/in to about 10 ft-lb/in, about 12 ft-lb/in, about 14 ft-lb/in, or about 16 ft-lb/in. In some embodiments, the first polyethylene copolymer can have a melt index (I_{2.16}) of about 0.2 g/10 min to about 1 g/10 min, a melt index ratio (I_{21.6}/I_{2.16}) of at least 30 to about 80, a density of about 0.910 g/cm³ to about 0.940 g/cm³, an Izod (impact) at 23° C. of about 8 ft-lb/in, about 9 ft-lb/in, about 10 ft-lb/in, or about 11 ft-lb/in to about 12 ft-lb/in, about 13 ft-lb/in, about 14 ft-lb/in, or about 15 ft-lb/in, an Izod (impact) at 0° C. of about 4 ft-lb/in, about 5 ft-lb/in, about 6 ft-lb/in, about 7 ft-lb/in, or about 8 ft-lb/in to about 10 ft-lb/in, about 12 ft-lb/in, about 14 ft-lb/in, or about 16 ft-lb/in, and a tensile (stress @ yield) of about 10 MPa, about 12 MPa, about 14 MPa, or about 16 MPa to about 18 MPa, about 20 MPa, about 22 MPa, or about 25 MPa.

In some embodiments, the first polyethylene copolymer can have a melt index (I_{2.16}) of about 0.2 g/10 min to about 1 g/10 min, a melt index ratio (I_{21.6}/I_{2.16}) of at least 30 to about 80, a density of about 0.910 g/cm³ to about 0.940 g/cm³, an Izod (impact) at 23° C. of about 8 ft-lb/in, about 9 ft-lb/in, about 10 ft-lb/in, or about 11 ft-lb/in to about 12 ft-lb/in, about 13 ft-lb/in, about 14 ft-lb/in, or about 15 ft-lb/in, an Izod (impact) at 0° C. of about 4 ft-lb/in, about 5 ft-lb/in, about 6 ft-lb/in, about 7 ft-lb/in, or about 8 ft-lb/in to about 10 ft-lb/in, about 12 ft-lb/in, about 14 ft-lb/in, or about 16 ft-lb/in, a tensile (stress @ yield) of about 10 MPa, about 12 MPa, about 14 MPa, or about 16 MPa to about 18 MPa, about 20 MPa, about 22 MPa, or about 25 MPa, and a shore hardness D of about 45, about 47, about 49, or about 51 to about 53, about 55, about 57, or about 60. In some embodiments, the first polyethylene copolymer can have a melt index (I_{2.16}) of about 0.2 g/10 min to about 1 g/10 min, a melt index ratio (I_{21.6}/I_{2.16}) of at least 30 to about 80, a density of about 0.910 g/cm³ to about 0.940 g/cm³, an Izod (impact) at 23° C. of about 8 ft-lb/in, about 9 ft-lb/in, about 10 ft-lb/in, or about 11 ft-lb/in to about 12 ft-lb/in, about 13 ft-lb/in, about 14 ft-lb/in, or about 15 ft-lb/in, an Izod (impact) at 0° C. of about 4 ft-lb/in, about 5 ft-lb/in, about 6 ft-lb/in, about 7 ft-lb/in, or about 8 ft-lb/in to about 10 ft-lb/in, about 12 ft-lb/in, about 14 ft-lb/in, or about 16 ft-lb/in, a tensile (stress @ yield) of about MPa, about 12 MPa, about 14 MPa, or about 16 MPa to about 18 MPa, about 20 MPa, about 22 MPa, or about 25 MPa, a shore hardness D of about 45, about 47, about 49, or about 51 to about 53, about 55, about 57, or about 60, and a 1% secant modulus of about 35,000 psi, about 40,000 psi, about 45,000 psi, about 50,000 psi, or about 55,000 psi to about 70,000 psi, about 80,000 psi, about 90,000 psi, about 95,000 psi, or about 100,000 psi.

In some embodiments, the first polyethylene copolymer can have a melt index (I_{2.16}) of about 0.2 g/10 min to about 1 g/10 min, a melt index ratio (I_{21.6}/I_{2.16}) of at least 30 to about 80, a density of about 0.910 g/cm³ to about 0.940 g/cm³, an Izod (impact) at 23° C. of about 8 ft-lb/in, about 9 ft-lb/in, about 10 ft-lb/in, or about 11 ft-lb/in to about 12 ft-lb/in, about 13 ft-lb/in, about 14 ft-lb/in, or about 15 ft-lb/in, an Izod (impact) at 0° C. of about 4 ft-lb/in, about 5 ft-lb/in, about 6 ft-lb/in, about 7 ft-lb/in, or about 8 ft-lb/in to about 10 ft-lb/in, about 12 ft-lb/in, about 14 ft-lb/in, or about 16 ft-lb/in, a tensile (stress @ yield) of about 10 MPa, about 12 MPa, about 14 MPa, or about 16 MPa to about 18 MPa, about 20 MPa, about 22 MPa, or about 25 MPa, a shore hardness D of about 45, about 47, about 49, or about 51 to about 53, about 55, about 57, or about 60, a 1% secant modulus of about 35,000 psi, about 40,000 psi, about 45,000 psi, about 50,000 psi, or about 55,000 psi to about 70,000 psi, about 80,000 psi, about 90,000 psi, about 95,000 psi, or about 100,000 psi, and a Vicat softening point of about 100° C., about 104° C., about 108° C., or about 112° C. to about 114° C., about 116° C., about 118° C., about 120° C., about 122° C., or about 125° C.

In some embodiments, the first polyethylene copolymer can have a melt index (I_{2.16}) of about 0.2 g/10 min to about 1 g/10 min, a melt index ratio (I_{21.6}/I_{2.16}) of at least 30 to about 80, a density of about 0.910 g/cm³ to about 0.940 g/cm³, an Izod (impact) at 23° C. of about 8 ft-lb/in, about 9 ft-lb/in, about 10 ft-lb/in, or about 11 ft-lb/in to about 12 ft-lb/in, about 13 ft-lb/in, about 14 ft-lb/in, or about 15 ft-lb/in, an Izod (impact) at 0° C. of about 4 ft-lb/in, about 5 ft-lb/in, about 6 ft-lb/in, about 7 ft-lb/in, or about 8 ft-lb/in to about 10 ft-lb/in, about 12 ft-lb/in, about 14 ft-lb/in, or about 16 ft-lb/in, a tensile (stress @ yield) of about 10 MPa, about 12 MPa, about 14 MPa, or about 16 MPa to about 18 MPa, about 20 MPa, about 22 MPa, or about 25 MPa, a shore hardness D of about 45, about 47, about 49, or about 51 to about 53, about 55, about 57, or about 60, a 1% secant modulus of about 35,000 psi, about 40,000 psi, about 45,000 psi, about 50,000 psi, or about 55,000 psi to about 70,000 psi, about 80,000 psi, about 90,000 psi, about 95,000 psi, or about 100,000 psi, a Vicat softening point of about 100° C., about 104° C., about 108° C., or about 112° C. to about 114° C., about 116° C., about 118° C., about 120° C., about 122° C., or about 125° C., and a second melting temperature of about 110° C., about 112° C., about 113° C., or about 115° C. to about 117° C., about 119° C., about 121° C., about 123° C., about 125° C., or about 127° C.

The Izod (impact) at 23° C. of the first polyethylene copolymer can be measured according to ASTM D256-10(2018), Method A. The Izod (impact) at 0° C. of the first polyethylene copolymer can be measured according to ASTM D256-10(2018). The environmental stress crack resistance (ESCR) of the first polyethylene copolymer can be measured ASTM D-1693-15, Condition A, 100% IGEPAL© F50. The notched, constant ligament-stress (NCLS) of the first polyethylene copolymer can be measured under the following conditions: 50° C., 600 psi, and 10% IGEPAL® F50. The tensile strength at yield of the first polyethylene copolymer can be measured according to ASTM D638-14. The shore hardness of the first polyethylene copolymer can be measured according to ASTM D 2240-15e1. The average flexural modulus (average 1% Secant Modulus) at 0.05 in/min of the first polyethylene copolymer can be measured according to ASTM D790-17, Procedure A. The Vicat softening point of the first polyethylene copolymer can be measured according to ASTM D1525-17e1, ION at 50° C./hr.

The second melting temperature (Tₘ₂) of the first polyethylene copolymer can be determined by first pressing a sample of the composition at elevated temperature and removing the sample with a punch die. The sample is then annealed at room temperature. After annealing, the sample is placed in a differential scanning calorimeter, e.g., Perkin Elmer 7 Series Thermal Analysis System, and cooled. Then the sample is heated to a final temperature and the first melting temperature (Tₘ₁) is recorded as the temperature of the greatest heat absorption within the range of melting of the sample. The sample is cooled and reheated to form a second melt, which is more reproducible than the first melt. The peak melting temperature from the second melt is recorded as the second melting temperature.

### Opaque or First Polymer Composition

The opaque or first polymer composition can be or can include, but is not limited to, any desired colored or opaque polymer suitable for extrusion blow molding. In some embodiments, the opaque or first polymer composition can be or can include, but is not limited to, one or more base polymers and one or more pigments, one or more colorants, one or more dyes, or a mixture thereof to produce the opaque polymer. Preparing opaque or colored polymer compositions is well known in the art. In some embodiments, the opaque or colored polymer can be or can include, but is not limited to, polyethylene, polypropylene, polyethylene terephthalate, polyethylene naphthalate, polyvinyl chloride, and/or other polymers.

In some embodiments, the opaque or first polymer composition can be or can include, but is not limited to, a second polyethylene copolymer derived from ethylene and at least one C₃ to C₂₀ α-olefin. In other embodiments, the opaque or first polymer composition can be or can include, but is not limited to, the second polyethylene copolymer and a post-consumer reclaimed polyethylene copolymer. In other embodiments, the opaque or first polymer composition can be or can include, but is not limited to, the second polyethylene copolymer and a post-consumer reclaimed polyethylene copolymer, where the post-consumer reclaimed polyethylene copolymer contains about 1 wt %, about 3 wt %, about 5 wt %, or about 7 wt % to about 10 wt %, about 11 wt %, about 13 wt %, or about 15 wt % of a polypropylene polymer.

The second polyethylene copolymer can have a density of about 0.930 g/cm³, about 0.935 g/cm³, about 0.940 g/cm³, about 0.945 g/cm³, or about 0.950 g/cm³ to about 0.955 g/cm³, about 0.960 g/cm³, or about 0.965 g/cm³. In some embodiments, the second polyethylene copolymer can have density that is greater than the first polyethylene composition. In other embodiments, the second polyethylene copolymer can have a density that is less than the first polyethylene composition. The second polyethylene copolymer can have an I_{2.16} (190° C./2.16 kg) of about 0.05 g/10 min, about 0.1 g/10 min, about 0.2 g/10 min, about 0.3 g/10 min or about 0.4 g/10 min to about 0.6 g/10 min, about 0.7 g/10 min, about 0.8 g/10 min, about 0.9 g/10 min, or about 1 g/10 min.

In some embodiments, if the opaque or first polymer composition includes the polypropylene polymer, the polypropylene polymer can have a melt flow index of less than 3, less than 2.7, less than 2.5, less than 2.3, or less than 2. In some embodiments, the opaque or first polymer composition can be or can include, but is not limited to, an impact polypropylene copolymer, a random polypropylene copolymer, a polypropylene homopolymer, or a mixture thereof.

In some embodiments, the second polyethylene copolymer can be produced with one or more Zeigler-Natta catalysts or one or more chromium-based catalysts. The second polyethylene copolymer can have a relatively broad molecular weight distribution. In some embodiments, the first polyethylene copolymer can be produced via one or more metallocene catalysts and the second polyethylene copolymer can be produced with one or more Zeigler-Natta catalysts or one or more chromium-based catalysts.

### Additives

The opaque or first polymer composition and/or the translucent or second polymer composition can include one or more additives. For example, the opaque or first polymer composition can include one or more pigments, dyes, or other colorants to provide or improve the opaque characteristic while also providing a container having a desired color. Illustrative additives can be or can include, but are not limited to, antioxidants, nucleating agents, acid scavengers, stabilizers, anticorrosion agents, plasticizers, blowing agents, cavitating agents, surfactants, adjuvants, block, antiblock, UV absorbers such as chain-breaking antioxidants, etc., quenchers, antistatic agents, slip agents, processing aids, UV stabilizers, neutralizers, lubricants, waxes, color masterbatches, pigments, dyes, fillers, and cure agents such as peroxide, or any mixture thereof. In some embodiments, the additives can each be present at 0.01 wt %, 0.1 wt %, or 1 wt % to 6 wt %, 10 wt %, or 50 wt %, based on the weight of the composition. In some embodiments, dyes and/or other colorants common in the industry can be present in the opaque or first polymer composition in an amount of 0.01 wt % to 10 wt % or 0.1 wt % to 6 wt %, based on the weight of the opaque or first polymer composition. Illustrative fillers, cavitating agents and/or nucleating agents can be or can include, but are not limited to, titanium dioxide, calcium carbonate, barium sulfate, silica, silicon dioxide, carbon black, sand, glass beads, mineral aggregates, talc, clay and the like.

### Extrusion Blow Molding Process

Containers that include the first polyethylene copolymer can be produced via extrusion blow molding, a process well-known in the art. Extrusion blow molding typically includes a cycle of steps. The steps in extrusion blow molding can include, but are not limited to, coextruding a first polymer composition and a second polymer composition to produce a hollow tube or parison having a first section that includes the first polymer composition and a second section that includes the second polymer composition, closing a mold around the parison, injecting a fluid into the mold to inflate the parison against an inner surface of the mold to form the container, and removing the container from the mold. As the mold closes around the parison the top of the parison can be pinched and the bottom of the parison can be sealed around a metal blow pin as the two halves of the mold come together. A fluid, e.g., air or nitrogen, can be injected into the parison within the mold, e.g., via the mandrel or a needle, to inflate the parison against an inner surface of the mold to form the container. In typical extrusion blow molding processes the sequence can be automated and usually integrated with downstream operations such as bottle filling and labeling. The extrusion blow molding can be a continuous (constant extrusion of the parison) or intermittent, which are both well-known processes.

The container can include a body having a top, a bottom, and a sidewall connected to the top and bottom. The body can define a volume. The first polymer composition can form the first section and can be opaque. The second polymer composition can form the second section and can be translucent to provide a viewing window into the volume. The second polymer composition can include a first polyethylene copolymer derived from ethylene and at least one C₃ to C₂₀ α-olefin. The first polyethylene copolymer can have an I_{2.16} (190° C./2.16 kg) of about 0.2 g/10 min to about 1 g/10 min, a melt index ratio of about 30 g/10 min to about 80 g/10 min, and a density of about 0.910 g/cm³ to about 0.940 g/cm³.

The extrusion blow molded container can be a single layer container or a multi-layer container. In other words, the first polymer composition and the second polymer composition can be co-extruded to produce a single layer parison or co-extruded with one or more additional polymer compositions to produce a multi-layer parison that can be inflated within the mold to produce a single layer container or a multi-layer container, respectively. In some embodiments, the extrusion blow molded container can include 1, 2, 3, 4, 5, 6, or 7 layers.

If the first polymer composition and the second polymer composition is co-extruded with one or more additional polymer compositions, the one or more additional polymer compositions can be or can include, but are not limited to, high density polyethylene, medium density polyethylene, low density polyethylene, linear low density polyethylene, polypropylene, propylene copolymers, co-polyester, polyethylene terephthalate, polyvinyl chloride, nylon, ethylene vinyl acetate, thermoplastic elastomers, cyclic olefin polymers, polycarbonates, acrylonitrile butadiene styrene polymers, and the like.

The extrusion blow molded container can have an average wall thickness of about 0.3 mm, about 0.5 mm, or about 0.7 mm to about 0.9 mm, about 1 mm, about 1.5 mm, or about 2 mm, about 2.5 mm, or about 3 mm, about 3.3 mm. In some embodiments, the extrusion blow molded container can have an average wall thickness of about 0.5 mm to about 3 mm, about 1 mm to about 3 mm, about 2 mm to about 3 mm, about 2.2 mm to about 2.8 mm, about 2 mm to about 2.5 mm, or about 2.5 mm to about 3 mm.

The extrusion blow molded container can be any of a number of a variety of container types. Illustrative extrusion blow molded containers that can be produced by extrusion blow molding can include, but are not limited to, industrial bulk containers; lawn, garden and household containers; medical supplies and parts; toys; building industry products; automotive-under the hood parts; and appliance components. In some embodiments, the extrusion blow molded container can be a motor oil container or bottle; an F-style handled jug; a fuel can; fertilizer, herbicide, pesticide, and other dispensers and sprayers; and any other container intended for mixing and measuring ingredients. In some embodiments, the extrusion blow molded container can be a motor oil bottle sized to contain about 946 mL of motor oil or about 4.73 L of motor oil. Fuel cans can be intended to contain gasoline, diesel, methanol, or the like. Dispensers and sprayers can include those operated by a manual hand pump and/or air pressured dispensers and sprayers.

### Processes for Making the First Polyethylene Copolymer

The first polyethylene copolymer can be made via any suitable polymerization method, e.g., gas phase, solution, or slurry polymerization processes. In some embodiments, the polyethylene can be made via a continuous gas phase polymerization using supported catalyst that can include an activated molecularly discrete catalyst in the substantial absence of an aluminum alkyl based scavenger, e.g., triethylaluminum (TEAL), trimethylaluminum (TMAL), triisobutyl aluminum (TIBAL), tri-n-hexylaluminum (TNHAL), and the like).

In some embodiments, a zirconium transition metal metallocene-type catalyst system can be used. Suitable metallocene catalysts and catalyst systems that can be used to produce the first polyethylene copolymer can include, but are not limited to, those disclosed in U.S. Pat. Nos. 5,466,649, 6,476,171, 6,225,426, and 7,951,873. In at least one example, the catalyst system can be or can include a supported dimethylsilyl bis(tetrahydroindenyl) zirconium dichloride catalyst.

In some embodiments, a supported polymerization catalyst can be deposited on, bonded to, contacted with, incorporated within, adsorbed or absorbed in, on, or otherwise contacted with a support or carrier. The metallocene catalyst can be introduced onto a support by slurrying a presupported activator in oil, a hydrocarbon such as pentane, solvent, or non-solvent, and then adding the metallocene as a solid while stirring. The metallocene can be in the form of finely divided solids. Although the metallocene is typically of very low solubility in the diluting medium, it is found to distribute onto the support and be active for polymerization. Very low solubilizing media such as a mineral oil or pentane can be used. The diluent can be filtered off and the remaining solid shows polymerization capability much as would be expected if the catalyst had been prepared by traditional methods such as by contacting the catalyst with methylalumoxane in toluene, contacting with the support, followed by removal of the solvent. If the diluent is volatile, such as pentane, it may be removed under vacuum or by nitrogen purge to afford an active catalyst. The mixing time can be greater than 4 hours, but shorter times are suitable.

In the gas phase polymerization process, a continuous cycle can be employed where in one part of the cycle of a reactor, a cycling gas stream, otherwise known as a recycle stream or fluidizing medium, can be heated in the reactor by the heat of polymerization. The heat can be removed in another part of the cycle by a cooling system external to the reactor. Illustrative processes can include those disclosed in U.S. Pat. Nos. 4,543,399; 4,588,790; 5,028,670; 5,317,036; 5,352,749; 5,405,922; 5,436,304; 5,453,471; 5,462,999; 5,616,661; and 5,668,228.

In a gas fluidized bed process for producing the first polyethylene copolymer, a gaseous stream containing the ethylene and comonomer can be cycled through a fluidized bed in the presence of the catalyst under reactive conditions. The gaseous stream can be withdrawn from the fluidized bed and recycled back into the reactor. The first polyethylene copolymer product can be withdrawn from the reactor and fresh monomer can be added to replace the polymerized monomers. The reactor pressure can vary from about 650 kPag, about 1,350 kPag, or about 1,750 kPa to about 2,400 kPag, about 2,800 kPag, or about 3,500 kPag. The reactor can be operated at a temperature of about 60° C., about 70° C., about 80° C., or about 90° C. to about 95° C., about 105° C., about 110° C., about 115° C., or about 120° C. The productivity of the catalyst or catalyst system can be influenced by the ethylene monomer partial pressure. The mole percent of the ethylene monomer can be from about 25 mol %, about 50 mol %, or about 70 mol % to about 80 mol %, about 85 mol %, or about 90 mol %. The ethylene partial pressure can be about 500 kPa-absolute, about 700 kPa-absolute, or about 1,000 kPa-absolute to about 1,700 kPa-absolute, about 1,850 kPa-absolute, or about 2,100 kPa-absolute.

Other gas phase processes that can be used to produce the first polyethylene copolymer can include, but are not limited to, those disclosed in U.S. Pat. Nos. 5,627,242, 5,665,818 and 5,677,375; EP0794200A; EP0802202A; and EPB0634421.

In some embodiments, it can be beneficial in slurry or gas phase processes to operate in the substantial absence of, or essentially free of, any scavengers, such as triethylaluminum, trimethylaluminum, triisobutylaluminum, and tri-n-hexylaluminum and diethyl aluminum chloride and the like. Such processes are described in PCT Publication No. WO 96/08520, which is herein fully incorporated by reference.

In some embodiments, the use of a process continuity aid, while not required, can be employed in any of the foregoing processes. Such continuity aids are well known to persons of skill in the art and include, for example, metal stearates.

In other embodiments, the first polyethylene copolymer can be produced according to the conditions disclosed in U.S. Pat. No. 5,763,543. In some embodiments, a catalyst system in which the metallocene has a pair of bridged cyclopentadienyl groups, preferably with the bridge including a single carbon, germanium, or silicon atom can be used so as to provide an open site on the catalytically active cation. The activator can be or can include, but is not limited to, methyl alumoxane as disclosed in U.S. Pat. Nos. 5,324,800; 5,580,939; and 5,633,394; EP0129368; or a noncoordinated anion as disclosed in EP0277004. In some embodiments, there can be substantially no scavenger(s) which may interfere with the reaction between the vinyl end unsaturation of polymers formed and the open active site on the cation. By the statement “substantially no scavengers”, it is meant that there should be less than 100 ppm by weight of such scavengers present in the feed gas, or preferably, no intentionally added scavenger, e.g., an aluminum alkyl scavenger, other than that which may be present on the support.

The conditions for the production of the first polyethylene copolymer can also include steady state polymerization conditions. As such, in some embodiments, the first polyethylene copolymer can be produced via a continuous gas phase process. For example, the first polyethylene copolymer can be produced by continuously circulating a feed gas stream containing monomers and inerts to thereby fluidize and agitate a bed of polymer particles, adding metallocene catalyst to the bed and removing polymer particles therefrom. The catalyst can include at least one bridged bis cyclopentadienyl transition metal and an alumoxane activator on a common or separate porous support. The feed gas can be substantially devoid of a Lewis acidic scavenger. By the statement “substantially devoid or free of Lewis acid scavenger”, it is meant that there should be less than 100 ppm by weight of such scavengers present in the feed gas, or preferably, no intentionally added scavenger other than that which may be present on the support. The temperature in the bed can be no more than 20° C. less than the first polyethylene copolymer melting temperature as determined by DSC at an ethylene partial pressure in excess of 414 kPa-absolute. The removed first polyethylene copolymer particles can have an ash content of transition metal of less than 500 wppm. The first polyethylene copolymer can have substantially no detectable chain end unsaturation as determined by HNMR, i.e., the first polyethylene copolymer can have a vinyl unsaturation of less than 0.1 vinyl groups per 1,000 carbon atoms in the first polyethylene copolymer, e.g., less than 0.05 vinyl groups per 1,000 carbon atoms or 0.01 vinyl groups per 1000 carbon atoms or less.

In some embodiments, the process can produce the first polyethylene copolymer via the use of a single catalyst and the process does not depend on the interaction of bridged and unbridged species. In some embodiments, the catalyst can be substantially devoid of a metallocene having a pair of pi bonded ligands, e.g., cyclopentadienyl compounds, which are not connected through a covalent bridge. In other words, in some embodiments, the first polyethylene copolymer can be produced with a single metallocene species that includes a pair of pi bonded ligands at least one of which has a structure with at least two cyclic fused rings, e.g., indenyl rings. In some embodiments, the single metallocene species can include a monoatom silicon bridge connecting two polynuclear ligands pi bonded to the transition metal atom.

In some embodiments, the catalyst can be supported on silica with the catalyst homogeneously distributed in the silica pores. In some embodiments, a fairly small amount of methyl alumoxane can be used such as an amount providing an Al to transition metal ratio of about 400 to about 30 or about 200 to 50.

In some embodiments, the molar ratio of the ethylene and comonomer can be varied to produce the first polyethylene copolymer having a desired melt index ratio. In some embodiments, controlling the temperature within the polymerization reactor can help control the melt index. In some embodiments, the overall monomer partial pressures can also be used, which corresponds to conventional practice for gas phase polymerization of LLDPE.

It should be understood that one or more additives can be added to the first polyethylene copolymer during pelletization/compounding of the first polyethylene copolymer. Illustrative additives can be or can include, but are not limited to, one or more stabilization agents such as antioxidants or other heat or light stabilizers; one or more anti-static agents; one or more crosslink agents or co-agents; one or more crosslink promoters; one or more release agents; one or more adhesion promoters; one or more plasticizers; one or more anti-agglomeration agents, such as oleamide, stearamide, erucamide or other derivatives with the same activity as known to the person skilled in the art; or any other additive and derivatives known in the art.

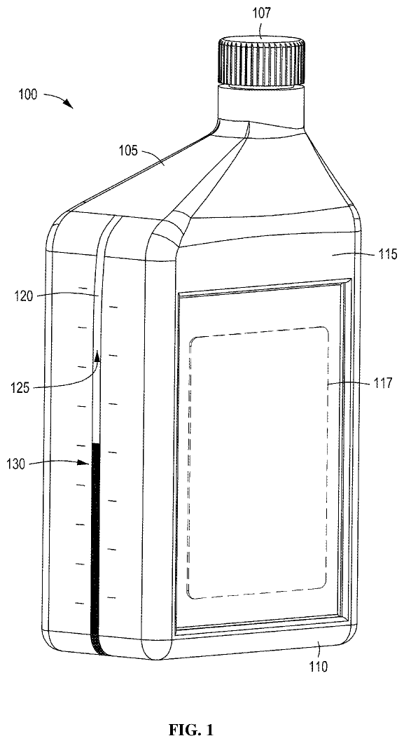

FIG. 1 depicts a schematic of an illustrative container 100, according to one or more embodiments. The container 100 can include a body that includes a top 105, a bottom 110, and a sidewall that includes a first section 115 and a second section 120 connected to the top 105 and the bottom 110. The body, i.e., the top 105, the bottom 110, the first section 115, and the second section 120, can define a volume 125. The first section 115 can be composed of an opaque polymer composition and the second section 120 can be composed of a translucent polymer composition. The second section 120 of the sidewall can provide a viewing window into the volume 125. In other words, the second section 120 can be the viewing window into the volume 125. The volume 125 can be configured to contain a fluid 130, a plurality of particles (not shown), or a mixture thereof (not shown). A level of the fluid 130 within the volume 125 can be seen through the second section 120 of the sidewall, i.e., the viewing window. The viewing window provided by the second section 120 of the body can allow visual inspection of the level of the fluid 130, the plurality of particles, or the mixture thereof.

In some embodiments, the translucent polymer composition can be or can include, but is not limited to, a first polyethylene copolymer derived from ethylene and at least one C₃ to C₂₀ α-olefin, where the first polyethylene copolymer can have an I_{2.16} (190° C./2.16 kg) of about 0.2 g/10 min to about 1 g/10 min, a melt index ratio of about 30 g/10 min to about 80 g/10 min, and a density of about 0.910 g/cm³ to about 0.940 g/cm³. In some embodiments, the opaque polymer composition can be or can include, but is not limited to, a second polyethylene copolymer derived from ethylene and at least one C₃ to C₂₀ α-olefin, the second polyethylene copolymer and a post-consumer reclaimed polyethylene copolymer, polypropylene, polyethylene terephthalate, polyethylene naphthalate, polyvinyl chloride, and/or other polymers.

In some embodiments, the top 105 can include a removable cap 107. In some embodiments, the cap 107 can be configured to seal and reseal the container 100 once opened. In other embodiments, the cap 107 can be configured to be removed and discarded once removed such that the container 100 can be a single use container or at least a container not configured to be resealed. For example, the cap 107 can be a removable pull tab or other single open type cap 107. In other embodiments, the cap 107 can be a screw-in cap configured with a manual pressurizing device or automatic pressurizing device, e.g., a top typically used for pressurized sprayers that can dispense a fluid therefrom. For sprayers and other dispensing containers one or more additional connections for one or more hoses and/or pressure release valves can also be incorporated into the container as is well-known in the art. In some embodiments, the container 100 can also include one or more areas 117 intended for product identification, e.g., product labeling, source identification, etc. In some embodiments, the container 100 can be in the form of an oil bottle, as shown, an F-style handled jug, a fuel can, fertilizer, herbicide, pesticide, and other dispensers and sprayers, or any other container intended for mixing and measuring ingredients, storing fluids and/or particles, and/or dispensing fluids and/or particles therefrom.

### EXAMPLES

The foregoing discussion can be further described with reference to the following non-limiting examples.

Inventive containers (Exs. 1-4) and comparative containers (CExs. 1-3) were produced by extrusion blow molding. The opaque polymer composition or first polymer composition used to produce the containers in Exs. 1-4 and CExs. 1-3 had a broad molecular weight distribution such as PAXON® AL55-003 and AA45-004, HD9830, and HYA600 available from ExxonMobil and MARLEX® HHD 5502BN available from Chevron Phillips. The translucent polymer composition or the first polyethylene copolymers that formed the viewing windows in Exs. 1-4 were produced with a metallocene catalyst. The translucent polymer compositions that formed the viewing windows in CExs. 1-3 were produced with either a Ziegler Natta or a Chromium based catalyst. The α-olefin comonomer used to produce the first polyethylene copolymer in Exs. 1-4 was 1-hexene. Properties of the polymers used to make the containers in Exs. 1-4 and CExs. 1-3 are provided in the Table below.

The copolymers were extrusion blow molded according to the following procedure. The blow molding process began by melting down the polyethylene copolymers at a temperature of about 200° C. to about 250° C. The melted polyethylene copolymers were coextruded and formed into a parison. The parison was clamped into a cooled mold, e.g., the mold was at a temperature of about 30° C. to about 50° C., and compressed air was blown into the mold. The air pressure, e.g., about 80 psi to about 90 psi, pushed the walls of the parison outward and into contact with an inner surface of the mold. Once the polyethylene copolymers cooled and hardened the mold was opened and the container was ejected therefrom.

The transmittance of the viewing windows for each example were measured according to ASTM D1746-15, with conditioning for 40 hours at a temperature of 23+/−2° C. and 50+/−10% relative humidity. The average transmittance was obtained by measuring each sample three times in the machine direction, three times in the transverse direction, adding those six values together and dividing by six. The average transmittance for two separate samples from each example were measured and are reported in the Table below. The viewing windows had a thickness of about 1.9 mm to about 2.1 mm.

| | | | | | Average | Average |
|---|---|---|---|---|---|---|
| | | | | | Trans- | Trans- |
| | MI- | MI- | | Den- | mittance | mittance |
| Example | 2 | 21 | MIR | sity | (%) | (%) |
| CEx. 1 | 0.35 | 34.03 | 103.1 | 0.955 | 0.70 | 0.70 |
| CEx. 2 | 0.40 | 35.33 | 88.30 | 0.956 | 0.00 | 0.00 |
| CEx. 3 | 0.40 | 28.69 | 71.70 | 0.955 | 0.40 | 0.30 |
| Ex. 1 | 1.00 | 34.04 | 34.00 | 0.921 | 6.70 | 6.90 |
| Ex. 2 | 0.29 | 15.85 | 54.70 | 0.928 | 1.60 | 2.00 |
| Ex. 3 | 0.19 | 9.61 | 50.58 | 0.916 | 2.20 | 2.10 |
| Ex. 4 | 0.50 | 21.15 | 42.30 | 0.920 | 8.80 | 9.40 |

As discussed above, the bottles produced by extrusion blow molding the first polymer composition and the second polymer composition that included the first polyethylene copolymer having an I_{2.16} (190° C./2.16 kg) of about 0.2 g/10 min to about 1 g/10 min, a melt index ratio of about 30 g/10 min to about 110 g/10 min, and a density of about 0.910 g/cm³ to about 0.957 g/cm³, surprisingly and unexpectedly were able to be used in combination with the opaque polymer composition to produce a container having a viewing window that had an average transmittance of at least 1%, as measured according to ASTM D1746-15. Furthermore, as shown in the Table above, all the inventive examples had a much greater average transmittance as compared to the conventional polymers used to make viewing windows. There was a significant visual difference in the level of average transmittance between the comparative examples and the inventive examples.

### Listing of Embodiments

This disclosure may further include the following non-limiting embodiments.

1. A container, comprising: a body comprising a top, a bottom, and a sidewall connected to the top and bottom, the body defining a volume, wherein a first section of the sidewall comprises an opaque polymer composition and a second section of the sidewall comprises a translucent polymer composition that provides a viewing window into the volume, wherein the translucent polymer composition comprises a first polyethylene copolymer derived from ethylene and at least one C₃ to C₂₀ α-olefin, and wherein the first polyethylene copolymer has: an I_{2.16} (190° C./2.16 kg) of about 0.2 g/10 min to about 1 g/10 min, a melt index ratio of about 30 g/10 min to about 80 g/10 min, and a density of about 0.910 g/cm³ to about 0.940 g/cm³.

2. A process for making a container, comprising: coextruding a first polymer composition and a second polymer composition to produce a parison having a first section comprising the first polymer composition and a second section comprising the second polymer composition; closing a mold around the parison; injecting a fluid into the mold to inflate the parison against an inner surface of the mold to form the container; and removing the container from the mold, wherein the container comprises a body having a top, a bottom, and a sidewall connected to the top and bottom, the body defining a volume, wherein the first polymer composition forms the first section and is opaque, wherein the second polymer composition forms the second section and is translucent to provide a viewing window into the volume, wherein the second polymer composition comprises a first polyethylene copolymer derived from ethylene and at least one C₃ to C₂₀ α-olefin, and wherein the first polyethylene copolymer has: an I_{2.16} (190° C./2.16 kg) of about 0.2 g/10 min to about 1 g/10 min, a melt index ratio of about 30 g/10 min to about 80 g/10 min, and a density of about 0.910 g/cm³ to about 0.940 g/cm³.

3. The container or process of paragraph 1 or 2, wherein the opaque polymer composition comprises a second polyethylene copolymer derived from ethylene and at least one C₃ to C₂₀ α-olefin, and wherein the second polyethylene copolymer has: a density of about 0.930 g/cm³ to about 0.965 g/cm³, and an I_{2.16} (190° C./2.16 kg) of about 0.05 g/10 min to about 1 g/10 min.

4. The container or process of paragraph 3, wherein at least a portion of the second polyethylene copolymer comprises a post-consumer reclaimed polyethylene copolymer.

5. The container or process of paragraph 1 or 2, wherein the opaque polymer composition comprises a blend of a polypropylene polymer and a second polyethylene copolymer, and wherein the second polyethylene copolymer has: a density of about 0.930 g/cm³ to about 0.965 g/cm³, and an I_{2.16} (190° C./2.16 kg) of about 0.05 g/10 min to about 1 g/10 min.

6. The container or process of paragraph 5, wherein the opaque polymer composition comprises up to 15 wt % of the polypropylene polymer, based on a combined weight of the polypropylene polymer and the second polyethylene copolymer.

7. The container or process of any of paragraphs 1 to 6, wherein, when the second section of the sidewall has an average thickness of about 1.9 mm to about 2.1 mm, the second section of the sidewall has an average transmittance of at least 1%, as measured according to ASTM D1746-15.

8. The container or process of any of paragraphs 1 to 6, wherein, when the second section of the sidewall has an average thickness of about 1.9 mm to about 2.1 mm, the second section of the sidewall has an average transmittance of at least 1.7%, as measured according to ASTM D1746-15.

9. The container or process of any of paragraphs 1 to 8, wherein the first polyethylene copolymer is produced with a metallocene catalyst.

10. The container or process of any of paragraphs 1 to 9, wherein the first polyethylene copolymer has a compositional distribution breadth index of at least 70%.

11. The container or process of any of paragraphs 1 to 10, wherein the first polyethylene copolymer has a density of less than 0.925 g/cm³.

12. The container or process of any of paragraphs 1 to 11, wherein the I_{2.16} (190° C./2.16 kg) of the first polyethylene copolymer is less than 0.5 g/10 min.

13. The container or process of any of paragraphs 1 to 10, wherein the I_{2.16} (190° C./2.16 kg) of the first polyethylene copolymer is less than 0.5 g/10 min and the density of the first polyethylene copolymer is at least 0.925 g/cm³.

14. The container o or process of any of paragraphs 1 to 10, wherein the I_{2.16} (190° C./2.16 kg) of the first polyethylene copolymer is 1 g/10 min or less and the density of the first polyethylene copolymer is less than 0.925 g/cm³.

15. The container or process of any of paragraphs 1 to 14, wherein the sidewall comprises a front wall, a back wall, a right wall, and a left wall, wherein the front wall and the back wall are substantially parallel, and wherein the right wall and the left wall are substantially parallel.

16. The container of any of paragraphs 1 or 3 to 15, wherein the container is made by extrusion blow molding.

17. The container or process of any of paragraphs 1 to 16, wherein the volume is configured to contain a fluid, a plurality of particles, or a mixture thereof.

18. The container or process of any of paragraphs 1 to 17, wherein the viewing window allows visual inspection of a level of a fluid, a level of a plurality of particles, or a mixture thereof located within the volume.

19. The container or process of any of paragraphs 1 to 18, wherein the top comprises a removable cap configured to seal and reseal the container once opened.

20. The container or process of any of paragraphs 1 to 19, wherein the container is an oil bottle, an F-style handled jug, or a fuel can.

21. The container or process of any of paragraphs 1 to 20, wherein a relationship between the 1% secant modulus (M) and the Dart Impact Strength (DIS) of the first polyethylene copolymer complies with the formula: DIS≥0.8×[100+e^{(11.71-0.000268M+2.183×10}^{^{−9}}^{×M}^{²}⁾], wherein e is the base Napierian logarithm, M is the averaged modulus in psi, and DIS is the 26 inch dart impact strength in g/mil.

22. The container or process of any of paragraphs 1 to 21, wherein a relationship between the 1% secant modulus (M) and the Dart Impact Strength (DIS) of the first polyethylene copolymer complies with the formula: DIS≥2.0×[100+e^{(11.71-0.000268M+2.183×10}^{^{−9}}^{×M}^{²}⁾], wherein e is the base Napierian logarithm and M is the averaged Modulus in psi and DIS is the dart impact strength, 26 inch, in g/mil.

23. The container or process of any of paragraphs 1 to 11 or 15 to 22, wherein the I_{2.16} (190° C./2.16 kg) of the first polyethylene copolymer is about 1 g/10 min, the density of the first polyethylene copolymer is less than 0.923 g/cm³, and the melt index ratio of the first polyethylene copolymer is about 33 to about 35.

24. The container or process of any of paragraphs 1 to 11 or 15 to 22, wherein the I_{2.16} (190° C./2.16 kg) of the first polyethylene copolymer is about 0.28 g/10 min to about 0.31 g/10 min, the density of the first polyethylene copolymer is less than 0.923 g/cm³, and the melt index ratio of the first polyethylene copolymer is greater than 50.

25. The container or process of any of paragraphs 1 to 11 or 15 to 22, wherein the I_{2.16} (190° C./2.16 kg) of the first polyethylene copolymer is about 0.23 g/10 min to about 0.27 g/10 min, the density of the first polyethylene copolymer is about 0.940 g/cm³, and the melt index ratio of the first polyethylene copolymer is greater than 60.

26. The container or process of any of paragraphs 1 to 11 or 15 to 22, wherein the I_{2.16} (190° C./2.16 kg) of the first polyethylene copolymer is about 0.4 g/10 min to about 0.6, the density of the first polyethylene copolymer is less than 0.922 g/cm³, and the melt index ratio of the first polyethylene copolymer is greater than 30.

27. The container process of any of paragraphs 1 to 10 or 15 to 22, wherein the I_{2.16} (190° C./2.16 kg) of the first polyethylene copolymer is about 0.25 g/10 min to about 0.35, the density of the first polyethylene copolymer is less than 0.930 g/cm³, and the melt index ratio of the first polyethylene copolymer is greater than 30.

28. The container or process of any of paragraphs 1 to 10 or 15 to 22, wherein the I_{2.16} (190° C./2.16 kg) of the first polyethylene copolymer is about 0.22 g/10 min to about 0.27, the density of the first polyethylene copolymer is about 0.940 g/cm³, and the melt index ratio of the first polyethylene copolymer is greater than 35.

29. The container or process of any of paragraphs 1 to 28, wherein the first polyethylene copolymer has an Izod (impact) at 23° C. of about 8 ft-lb/in to about 15 ft-lb/in.

30. The container or process of any of paragraphs 1 to 29, wherein the first polyethylene copolymer has an Izod (impact) at 0° C. of about 4 ft-lb/in to about 16 ft-lb/in.

31. The container or process of any of paragraphs 1 to 30, wherein the first polyethylene copolymer has a tensile (stress @ yield) of about 10 MPa to about 25 MPa.

32. The container or process of any of paragraphs 1 to 31, wherein the first polyethylene copolymer has a shore hardness D of about 45 to about 60.

33. The container or process of any of paragraphs 1 to 32, wherein the first polyethylene copolymer has a 1% secant modulus of about 35,000 psi to about 100,000 psi.

34. The container or process of any of paragraphs 1 to 33, wherein the first polyethylene copolymer has a Vicat softening point of about 100° C. to about 125° C.

35. The container or process of any of paragraphs 1 to 34, wherein the first polyethylene copolymer has a second melting temperature of about 110° C. to about 127° C.

36. The container or process according to any of paragraphs 1 to 35, wherein the first polyethylene copolymer has a molecular weight distribution (Mw/Mn) of about 2 to about 6.5.

Unless otherwise indicated, all numbers indicating quantities in this disclosure are to be understood as being modified by the term “about” in all instances. It should also be understood that the precise numerical values used in the specification and claims constitute specific embodiments. Efforts have been made to ensure the accuracy of the data in the examples. However, it should be understood that any measured data inherently contains a certain level of error due to the limitation of the technique and/or equipment used for making the measurement.

Certain embodiments and features are described herein using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A container, comprising:
a body comprising a top, a bottom, and a sidewall connected to the top and bottom, the body defining a volume, wherein a first section of the sidewall comprises an opaque polymer composition and a second section of the sidewall comprises a translucent polymer composition that provides a viewing window into the volume, wherein the translucent polymer composition comprises a first polyethylene copolymer derived from ethylene and at least one C₃ to C₂₀ α-olefin, and wherein the first polyethylene copolymer has:
an I_{2.16} (190° C./2.16 kg) of about 0.2 g/10 min to about 1 g/10 min,
a melt index ratio of about 30 g/10 min to about 80 g/10 min, and
a density of about 0.910 g/cm³ to about 0.940 g/cm³.

2. The container of claim 1, wherein the opaque polymer composition comprises a second polyethylene copolymer derived from ethylene and at least one C₃ to C₂₀ α-olefin, and wherein the second polyethylene copolymer has:
a density of about 0.930 g/cm³ to about 0.965 g/cm³, and
an I_{2.16} (190° C./2.16 kg) of about 0.05 g/10 min to about 1 g/10 min.

3. The container of claim 2, wherein at least a portion of the second polyethylene copolymer comprises a post-consumer reclaimed polyethylene copolymer.

4. The container of claim 1, wherein the opaque polymer composition comprises a blend of a polypropylene polymer and a second polyethylene copolymer, and wherein the second polyethylene copolymer has:
a density of about 0.930 g/cm³ to about 0.965 g/cm³, and
an I_{2.16} (190° C./2.16 kg) of about 0.05 g/10 min to about 1 g/10 min.

5. The container of claim 4, wherein the opaque polymer composition comprises up to 15 wt % of the polypropylene polymer, based on a combined weight of the polypropylene polymer and the second polyethylene copolymer.

6. The container of claim 1, wherein, when the second section of the sidewall has an average thickness of about 1.9 mm to about 2.1 mm, the second section of the sidewall has an average transmittance of at least 1%, as measured according to ASTM D1746-15.

7. The container of claim 1, wherein, when the second section of the sidewall has an average thickness of about 1.7 mm to about 2.1 mm, the second section of the sidewall has an average transmittance of at least 1.9%, as measured according to ASTM D1746-15.

8. The container of claim 1, wherein the first polyethylene copolymer is produced with a metallocene catalyst.

9. The container of claim 1, wherein the first polyethylene copolymer has a compositional distribution breadth index of at least 70%.

10. The container of claim 1, wherein the first polyethylene copolymer has a density greater than or equal to 0.910 g/cm³, and less than 0.925 g/cm³.

11. The container of claim 1, wherein the I_{2.16} (190° C./2.16 kg) of the first polyethylene copolymer is greater than or equal to 0.2 g/10 min and less than 0.5 g/10 min.

12. The container of claim 1, wherein the I_{2.16} (190° C./2.16 kg) of the first polyethylene copolymer is greater than or equal to 0.2 g/10 min and less than or equal to 1 g/10 min, and the density of the first polyethylene copolymer is greater than or equal to 0.910 g/cm³ and less than 0.925 g/cm³.

13. The container of claim 1, wherein the sidewall comprises a front wall, a back wall, a right wall, and a left wall, wherein the front wall and the back wall are substantially parallel, and wherein the right wall and the left wall are substantially parallel.

14. The container of claim 1, wherein the container is made by extrusion blow molding.

15. The container of claim 1, wherein the volume is configured to contain a fluid, a plurality of particles, or a mixture thereof.

16. The container of claim 1, wherein the viewing window allows visual inspection of a level of a fluid, a level of a plurality of particles, or a mixture thereof located within the volume.

17. The container of claim 1, wherein the top comprises a removable cap configured to seal and reseal the container once opened.

18. The container of claim 1, wherein the container is an oil bottle, an F-style handled jug, or a fuel can.

19. A process for making a container, comprising:
coextruding a first polymer composition and a second polymer composition to produce a parison having a first section comprising the first polymer composition and a second section comprising the second polymer composition;
closing a mold around the parison;
injecting a fluid into the mold to inflate the parison against an inner surface of the mold to form the container; and
removing the container from the mold, wherein the container comprises a body having a top, a bottom, and a sidewall connected to the top and bottom, the body defining a volume, wherein the first polymer composition forms the first section and is opaque, wherein the second polymer composition forms the second section and is translucent to provide a viewing window into the volume, wherein the second polymer composition comprises a first polyethylene copolymer derived from ethylene and at least one C₃ to C₂₀ α-olefin, and wherein the first polyethylene copolymer has:
an I_{2.16} (190° C./2.16 kg) of about 0.2 g/10 min to about 1 g/10 min,
a melt index ratio of about 30 g/10 min to about 80 g/10 min, and
a density of about 0.910 g/cm³ to about 0.940 g/cm³.
